(19) United States
(12) Patent Application Publication
(10) Pub. No.: US 2004/0224715 A1
(43) Pub. Date: Nov. 11, 2004

(54) System and method for correcting transmitter impairments

(76) Inventors: John R. Rosenlof, La Mesa, CA (US); Kirupairaj Asirvatham, Escondido, CA (US)

Correspondence Address: W. James Brady III, Texas Instruments Incorporated, M/S 3999, PO Box 655474, Dallas, TX, 75265, US

(21) Appl. No.: 10/790,525

(22) Filed: Mar. 1, 2004

Related U.S. Application Data
(60) Provisional application No. 60/468,753, filed on May 7, 2003.

(51) Int. Cl. G05B 23/02; H04B 7/00; H04Q 7/20

(52) U.S. Cl. 455/522; 455/517

(57) ABSTRACT

Systems and methods are disclosed to improve a transmitter output signal. In one aspect, a correction system includes a power detector that provides an indication of power associated with a transmitter output signal. A compensation system employs the indication of power to compensate for at least one transmitter impairment affecting the transmitter output signal.

### RELATED APPLICATION

This patent application claims the benefit of U.S. Provisional Patent Application No. 60/468,753, which was filed May 7, 2003 and entitled WLAN Radio Transmitter Calibration Using A Transmit Power Detector, the entire contents of which is incorporated herein by reference.

### TECHNICAL FIELD

The present invention relates generally to communications devices and more particularly to systems and methods for correcting transmitter impairments.

### BACKGROUND

Wireless local area networks (WLANs) have been developed for various commercial and residential applications. Such networks allow for mobile terminals to be moved within a particular service area without regard to a physical connection to the network. To enable communications in the WLAN, various wireless standards have been developed, including the IEEE 802.11x standard, Blue Tooth, and hiperlan, to name a few. The architectural and operational parameters associated with these and other types of wireless communications systems can cause significant distortions in the signals. Both the radio transmitter and receiver can contribute to these distortions.

Of particular interest are impairments in a WLAN system caused by a transmitter, including in-phase (I) and quadrature (Q) phase and amplitude imbalance, attenuation distortion in the transmit band and carrier level. Some possible sources of phase and gain mismatches in WLAN radios include differences in filter characteristics between the I and Q paths (e.g., due to semi-conductor process variations), which can result in both gain and phase imbalances that are generally frequency dependent. Additionally, differences in the I and Q path delays can cause phase imbalance that is proportional to frequency. A quadrature mixer that combines the I and Q components for transmission can also contribute to the total imbalance because of the gain and phase imbalance of the quadrature mixing signals.

Many transmitter architectures employ multiple stages of filtering, each of which can contribute to amplitude distortion of the signal, such as due to ripple characteristics across the band for orthogonal frequency division multiplexing (OFDM) signals. The amplitude distortion may cause some OFDM tones to be attenuated several DB below other tones. This can result in a lower signal-to-noise ratio for the tones in the band thereby increasing the packet error rate. While the amplitude distortions in the OFDM tones can be equalized in the receiver, such equalization in the receiver also tends to enhance associated noise.

An additional source of error in many WLAN architectures relates to an amplitude spike at the carrier frequency. For example, many transmitter implementations cause leakage at the center frequency component. WLAN standards specify requirements of the level for the center frequency component with respect to the overall power of the WLAN signal. Factory calibration typically is implemented to set the set of frequency components within the specified standard. However, the carrier level may change during operation due to changes in temperature or due to parts aging to the extent where the transmitter no longer meets the standard specifications.

### SUMMARY OF THE INVENTION

The present invention relates to systems and methods for correcting transmitter impairments. According to one embodiment of the present invention, a correction system includes a power detector that provides an indication of power associated with a transmitter output signal. A compensation system employs the indication of power to compensate for at least one transmitter impairment affecting the transmitter output signal. The transmitter impairment corrected by the compensation system can include, for example, spikes in a carrier signal, equalization errors, as well as gain and/or phase mismatch in in-phase and quadrature signal components. The correction system can be implemented as hardware, software or a combination of hardware and software.

According to another embodiment of the present invention, a communications apparatus can include a baseband system that provides in-phase (I) and quadrature (Q) signal components. A correction system associated with the baseband system is operative to adjust at least one of the I and Q signal components based on an indication of power of a transmit signal to compensate for impairments associated with the communications apparatus. A power detector detects power provides the indication of power. A transmitter thus provides the transmit signal based on the adjusted I and Q signal components. As a result, the impairments are mitigated.

Still another aspect of the present invention provides a method to correct impairments associated with a communications apparatus. The method includes detecting an indication of power associated with a transmit signal (e.g., by a power detector). An in-phase (I) signal component and/or a quadrature (Q) signal component is adjusted based on the indication of power to compensate for impairments associated with the communications apparatus that affect the transmit signal. The method can also implement calibration to set the adjustments to the I and/or Q signal components, which calibration can be implemented as an online or offline process.

### BRIEF DESCRIPTION OF THE DRAWINGS

The foregoing and other aspects of the present invention will become apparent to those skilled in the art to which the present invention relates upon reading the following description with reference to the accompanying drawings.

FIG. 1 depicts a transmitter system implementing a calibration system in accordance with an aspect of the present invention.

FIG. 2 depicts an example of a transmitter configured to implement error correction in accordance with an aspect of the present invention.

FIG. 3 depicts a block diagram of a carrier correction system in accordance with an aspect of the present invention.

FIG. 4 depicts an example of a system for correcting I/Q mismatch errors.

FIG. 5 depicts an example of an equalization system in accordance with an aspect of the present invention.

FIG. 6 depicts an example of a sample transmit spectrum before equalization.

FIG. 7 depicts a graph depicting a power detector response that can be utilized in accordance with an aspect of the present invention.

FIG. 8 is a flow diagram illustrating a compensation method that can be implemented in accordance with an aspect of the present invention.

FIG. 9 is a flow diagram depicting a methodology for implementing carrier correction in accordance with an aspect of the present invention.

FIG. 10 is a flow diagram depicting a methodology for correcting I/Q mismatches in accordance with an aspect of the present invention.

FIG. 11 is a flow diagram depicting a methodology for implementing equalization in accordance with an aspect of the present invention.

### DETAILED DESCRIPTION

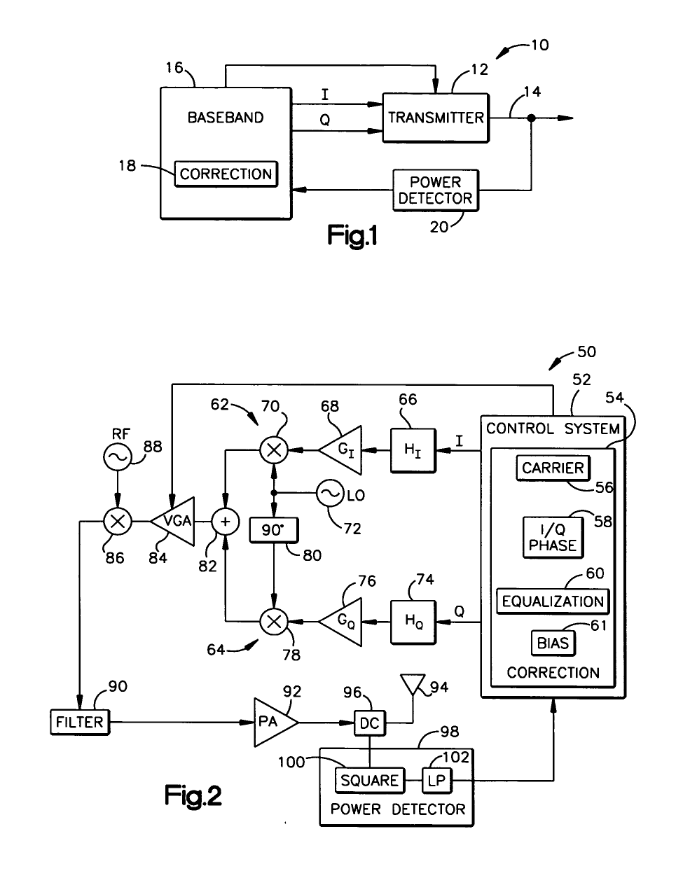

FIG. 1 depicts an example of a communications system 10 that can be implemented in accordance with an aspect of the present invention. The system 10 can be implemented as a transmitter or a transceiver that includes a transmitter 12 configured to transmit a wireless output signal 14. A baseband system 16 provides in-phase (I) and quadrature (Q) signal components to the transmitter, based on which the transmitter provides the signal 14. A correction system 18 is associated with the baseband system 16 to correct for impairments in the system 10. The corrections can compensate for impairments associated with various aspects of system operation, such as by selectively adjusting characteristics of the I and/or Q signal components that are provided to the transmitter 12. The correction system 18 can be implemented as part of the baseband system 16 or separate from the baseband system.

According to an aspect of the present invention, the correction system 18 estimates correction based on a measure of energy in the transmitter output signal 14. To measure the energy, the system 10 thus employs a power detector 20 that is coupled to detect the power associated with the output signal 14 provided by the transmitter 12. The power detector 20 provides an indication of the output power to the baseband system 16. The correction system 18 employs the indication of output power provided by the power detector 20 to implement the desired correction. Those skilled in the art will understand and appreciate various types of circuitry that can be utilized to detect power associated with the output signal 14. For example, many transmitter systems already implement power detectors utilized as feedback mechanisms for controlling the transmit power. Accordingly, the correction system 18 can leverage existing power detection circuitry.

By way of further example, the correction system 18 can be configured during a calibration mode. The calibration mode can involve one or more calibration phases based on the number and type of impairments to be corrected. For instance, the correction system can be programmed in a first phase to correct for spikes in the carrier level, in a second phase to correct for I/Q mismatches and in a third phase to equalize the signal spectrum.

By amplifying the output of the power detector 20 (the indication of power) sufficiently, the power level of individual tones or sets of tones provided by the baseband system 16 can be measured to estimate impairments in the transmitter system 10. To facilitate implementing desired correction for the system 10, the corrections can be implemented based on relative measurements within the system, such as by employing power ratios (e.g., between the respective I and Q signal components) rather than based on the absolute detected power levels. Thus, the correction system 18 can utilize the estimated impairment to selectively adjust the I and Q signal components to correct for such impairments without requiring calibration of the power detector.

As an example, the correction system 18 can be adapted to correct for spikes in the carrier signal. Spikes in the carrier signal can be mitigated by selectively adjusting DC levels of one or both of the I and Q signal components based on the indication of power provided by the power detector 20. This can be implemented during a first calibration mode in which data and other information has been removed from the I and Q signal components provided to the transmitter 12. The correction module 18 can then adjust the DC level of the I and Q signal components until a desired signal level is achieved for the carrier.

Additionally, the correction system 18 can correct for I/Q mismatches in the transmitter system 10. The I/Q mismatches, for example, can correspond to phase and gain mismatches due to variations between the signal paths associated with the respective I and Q signal components. These mismatches can corrupt the transmitted signal thereby increasing the bit error rate when the signal is finally demodulated at a receiver (not shown). In addition, phase and gain imbalances in the quadrature mixer of the radio device can combine with the signal path differences to further exacerbate the degradation. One possible source of the mismatch include semiconductor process variations, which can result in both gain and phase imbalances that are generally frequency dependent. Additionally, differences in the I and Q path delays can impose a phase imbalance generally proportional to frequency. A quadrature mixer in the transmitter 12 can further contribute to the total imbalance because of gain and phase imbalances of the quadrature mixing signals.

Thus, to compensate for the I/Q mismatches, the correction system 18 can employ the power detector 20 to measure the power associated with each of the I and Q signal components. For example, the correction system 18 can independently control the relative magnitude and sign of the respective I and Q signal components over a plurality of signals. The corresponding measure of power provided by the power detector 20 can in turn be utilized to ascertain both the phase imbalance and the gain mismatch associated with the respective I and Q signal components.

The correction system 18 can also compensate for attenuation distortion associated within the signal spectrum or band. For example, the correction system 18 can control the baseband system 16 to provide desired calibration tones, with the power detector 20 measuring corresponding power for each tone. The correction system 18 can compute factors or weights to pre-correct the transmit tone levels based on the indication of power provided by the power detector for each individual tone. For example, a reference tone (e.g., corresponding to one of the calibration tones) can be utilized as a basis to which all the other tones are corrected by applying suitable weighting parameters to adjust their respective power levels. The correction system 18 thus can employ the weight factors to achieve a desired shape for the signal spectrum (e.g., equalization).

It is to be understood and appreciated that the transmitter system 10 can be configured to implement any one or more of the modes of correction described herein. The calibration of the transmitter system 10 can be implemented by the correction system 18 at power up and/or intermittently during normal operation to achieve desired performance.

FIG. 2 depicts an example of a communication system (e.g., a transmitter portion) 50 that can be implemented in accordance with an aspect of the present invention. The system 50 includes a control system 52 that is programmed and/or configured to implement desired correction to improve operation of the system 50. In particular, the control system 52 includes a correction component 54 that is operative to calibrate characteristics of the communication system 50 based on an output power level, namely a transmit power. The control system 52 employs the correction component 54 to provide compensated quadrature baseband input signals, namely an in-phase (I) signal component and a quadrature (Q) signal component. As described herein, the correction component 54 is operative to mitigate errors or impairments by implementing desired compensation on one or both of the I and Q components.

According to an aspect of the present invention, the correction component 54 can include a carrier correction component 56, an I/Q gain and/or phase correction component 58 and an equalization component 60. It will be understood and appreciated that improved performance can be achieved by utilizing one or any combination of such correction components 56-60.

The communications system 50 includes separate paths 62 and 64 for the respective I and Q signal components. The control system 52 provides the I signal component to a baseband filter block (H_{I}) 66, which can include one or more filters. The baseband filter block 66 is configured to provide a desired frequency response for the I-signal component. The baseband filter block 66 provides a corresponding output signal to an amplifier 68 having a gain (Gᵢ) that amplifies the signal to a desired level. The amplified output signal is provided to a mixer 70. The mixer 70 mixes the output signal from the amplifier 68 with a signal provided by a local oscillator 72. The mixer 70 thus combines the amplified output signal with the carrier provided by the local oscillator 72 to produce corresponding I signal component for the I-signal path 62.

With regard to the Q signal path 64, the control system 52 provides the Q signal component to a baseband filter block 74 (H_{Q}) (e.g., one or more filters) that implements a desired frequency response on the Q signal component. The baseband filter block 74 provides a corresponding output signal to an amplifier 76 having a gain (G_{Q}) that amplifies the filtered Q signal component to a desired level. The amplifier 76 provides the amplified signal to a mixer 78, which combines the amplified signal with a phase shifted carrier signal. In this example, the local oscillator 72 provides the carrier signal to a quadrature phase shift component 80 that provides a phase shifted carrier signal to the mixer 78. The mixer provides the Q signal component at a desired frequency (e.g., an intermediate frequency) to a combiner 82.

The combiner 82 combines the I and Q signal components and provides the aggregate signal to a variable gain amplifier 84. The control system 52 can provide a control signal to the amplifier 84 to selectively set the gain of the amplifier. The amplifier 84 provides an amplified aggregate signal to another mixer 86 that combines the aggregate amplified signal with a desired carrier frequency provided by a radio frequency (RF) synthesis component 88. The mixer 86 produces a signal having a desired transmission frequency that is provided to a filter 90. The filter 90 implements a transfer function (e.g., a bandpass filter) to achieve a desired frequency response. The filter 90 provides a filtered output signal to an associated power amplifier (PA) 92. The power amplifier 92 provides the corresponding amplified output signal to an antenna 94 through a directional coupler (DC) 96. The power amplifier 92 is configured to amplify the filtered signal to a desired level for transmission.

A power detector 98 is operatively coupled to the directional coupler 96 to detect transmission power. The power detector 98 provides a power detection signal to the control system 52 indicative of a measure of energy associated with the transmit signal. By way of example, the power detector 98 can be implemented by circuitry implementing a squaring function (or an absolute value function) 100 that is provided to a low pass filter 102 to remove high frequency signal components from the signal.

The control system 52 employs the measure of energy provided by the power detector 98 to implement appropriate compensation and calibration of one or more transmitter impairments associated with distortion in the output signal. As mentioned above, the compensation implemented by the correction module 54 can correct for one or more of carrier spikes, I/Q gain and/or phase mismatches as well as adjust the spectral shape of the transmit output signal.

For example, the carrier correction component 56 can be programmed or configured during a calibration mode for each of the I and Q signal components. For instance, a test signal having no information (e.g., only DC signals) can be provided to the I signal path 62 while no signal is provided to the Q signal path 64. The carrier correction component 56 can optimize the I signal component based on the measure of energy provided by the power detector 98. After a desired power level is achieved for the I signal component, the carrier correction component 56 can apply a DC signal to the Q signal component path 64, while no signal is provided to the I signal path 62. The carrier correction component 56 can then implement desired compensation/optimization for the Q signal path 64 based on the measure of power indicated by the signal provided by the power detector 98.

The I/Q correction component 58 can correct one or both I/Q gain and phase mismatch based on an indication of the I/Q mismatch determined during an associated calibration process. The calibration process can include providing suitable calibration tones to the I and/or Q signal paths 62 and 64. The I/Q correction component 58 can estimate gain and phase mismatch based on the power detection signal provided by the power detector 98 for respective calibration tones for each of the I and Q signal paths 62 and 64. The gain and phase estimates calculated by the I/Q correction component 58 can modify the respective I and Q signal components during normal operation to compensate for the mismatches determined during calibration. As a result, the transmit signals can be dynamically adjusted during normal operation to compensate for imbalances in the gain and phase associated with the respective signal paths 62 and 64.

The equalization correction component 60 employs a series of calibration tones for a given frequency spectrum (or band) to ascertain an appropriate level of correction for each tone in the frequency band based on power detector measurements for each tone. The equalization correction component 60 determines a weighting factor to apply to the respective tones to compensate for signal attenuation across the frequency spectrum, thereby equalizing the transmit levels relative to that of a reference tone selected during calibration. During normal operation, the equalization component 60 applies pre-correction to the transmit tone levels, such that the frequency band or spectrum can maintain an improved equalization across the band.

The correction system 54 also can include a bias correction component 61 programmed and/or configured to compensate for DC bias associated with the power detector 98. The bias correction component 61, for example, determines a value indicative of DC bias associated with operation of the power detector 98. The equalization component 60 and the I/Q correction component 58 can, in turn, employ the detector bias value when performing corresponding compensation implemented by such components. That is, these components 58 and 60 can mitigate error injected into the power measurements by the power detector based on the detector bias value.

Where the correction system 54 is implemented to include carrier correction component 56, I/Q correction component 58 and equalization correction component 60, it is desirable to calibrate the correction system 54 for carrier level first, for I/Q mismatch next and for equalization after carrier level and I/Q mismatch calibration. This approach mitigates the impact that each of the previously corrected impairments may have on the subsequently calibrated features.

Those skilled in the art will appreciate various types of transmitter architectures that can implement correction based on the teachings contained herein. For example, not all transmitter designs may require implementing each of the modes of compensation, including carrier suppression, I/Q mismatch correction, and equalization. Accordingly, those skilled in the art will understand how to implement appropriate aspects of correction as well as how to implement calibration thereof based on the teachings contained herein.

By way of further example, FIG. 3 depicts an example of a carrier correction system 150 that can be implemented in accordance with an aspect of the present invention. The carrier correction system 150 includes a signal generator 152 that is operative to provide I and Q signal components. In particular, the signal generator 152 includes a DC_{I} block 154 that is operative to provide a DC bias to the I-signal path and a DC_{Q} block 156 that is operative to provide a DC bias to the Q signal path. A carrier offset correction module 158 controls the DC_{I} and DC_{Q} blocks 154 and 156, respectively.

The carrier offset correction module 158 can perform optimization for the I and Q channels to compensate for low frequency leakage associated with the transmitter to which the I and Q signal components are provided. The carrier offset correction module 158 implements the adjustments to the I and Q signal based on a measure of energy associated with a transmit power based on the I and Q signal components provided by the signal generator 152, such as determined during a calibration mode. The carrier correction system 150 receives a POWER signal indicative of a measure of transmitter carrier energy, such as from a power detector (see, e.g., FIG. 2). An analog-to-digital converter 160 converts the POWER signal to a digital representation thereof. A power measurement component 162 determines an indication of measured power based on the digital representation of power provided by the A/D converter 160. The power measurement component provides the indication of power to the carrier offset correction module 158. The carrier offset correction module 158 in turn employs the calculated power to control the DC offset for each of the I and Q signal paths.

By way of example, the carrier offset correction module 158 adjusts the DC bias for the I-signal path to achieve a desired power level while no signal is provided to the Q signal path. After achieving a desired power level with the I-signal path, the carrier offset correction module 158 selectively adjusts the DC bias for the Q signal by adjusting the DC bias for the I-signal path (DC_{I}) and the DC bias signal for the Q signal path (DC_{Q}). Thus, the signal generator 152 employs the DC_{I} and DC_{Q} blocks 154 and 156 to provide signals without energy in the in-band frequencies, such that only the carrier frequency remains. The carrier offset correction module 158 can ascertain a set of DC inputs that minimizes the carrier component in the transmission signal based on the calculated power provided by the power measurement component 162 for each of the adjusted DC bias levels.

By way of further example, in transmitter devices that employ DC coupling to the baseband inputs, carrier offset can be controlled by adjusting complex I and Q signal components, indicated at I_{T} and Q_{T}. For instance, by setting I_{T}=DC_{I} and Q_{T}=DC_{Q}, the signal S(t) provided (e.g., by a power amplifier to a power detector) can be represented as:

S(t)∝DC_{I} cos(ω_{c}t+φ)−DC_{Q} sin(ω_{c}t+φ) Eq. 1

where ω_{c} corresponds to the carrier frequency, and

φ denotes an arbitrary phase of the transmit signal.

From Eq. 1, it will be appreciated that a set of DC inputs can be determined to minimize the carrier component in the transmit signal. The set of DC inputs can be determined, for example, by the carrier offset correction module 158 selectively adjusting DC_{I} and DC_{Q} while measuring an indication of the power (e.g., corresponding to the carrier level) with the power detector for each adjustment. As a result, a desired set of DC inputs can be determined to configure DC inputs that provide a minimum carrier level during normal operation.

Those skilled in the art will appreciate various optimization algorithms that can be utilized to determine suitable DC bias levels for the respective I and Q signal components to mitigate the carrier spikes that might otherwise occur. Since erroneous energy in the carrier might corrupt measurements associated with the I/Q signal phases, it is desirable to calibrate the carrier correction system 150 prior to calibrating for I/Q gain and phase mismatches, as described herein.

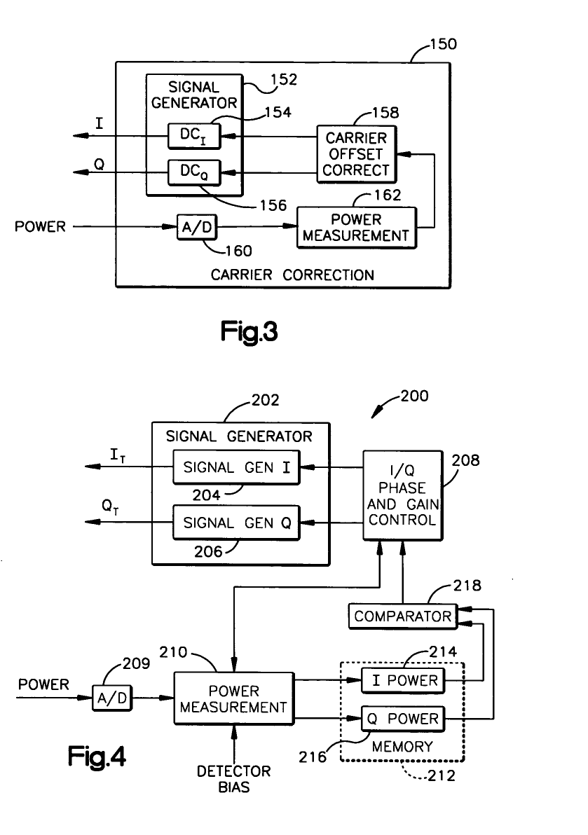

FIG. 4 depicts an example of an I/Q mismatch correction system 200. The system 200 is programmed and/or configured to ascertain an indication of gain and phase mismatch for I and Q signal paths of an associated transmitter. The mismatches between the I and Q signal components, for example, can be associated with different filter characteristics in the I and Q signal paths, such as may be due to semiconductor process variations. Additionally, there can be different path delays associated with the I and Q signal paths that can cause further imbalances which may be proportional to frequency. A quadrature mixer employed by transmitter circuitry further can contribute to the total imbalance of the gain and phase of the mixing between the signals.

The system 200 receives a POWER signal indicative of a measure of energy associated with a transmit signal based on I and/or Q signal components provided by the system 200. The system 200 includes a signal generator 202 that includes signal generator block 204 for the I-signal path and a signal generator block 206 for the Q signal path. An I/Q phase control 208 is operative to control the signal generator blocks 204 and 206 to achieve desired calibration to mitigate impairments, such as due to gain and phase mismatches. The I/Q phase control 208 ascertains gain and phase mismatches, for example, based on measures of energy provided by a power detector in conjunction with selected signals provided to the transmitter on the I and Q signal paths during an I/Q calibration mode.

During the calibration mode, for example, an A/D converter 209 provides a digital indication of power to a power measurement component 210. The measurement component 210 determines an indication of power for the respective calibration tones provided by the signal generator for each of the I and Q signal paths. By independently applying each calibration tone to each of the I and Q signal paths, a measure of power can be obtained separately for the I-signal path and for the Q signal path. The power measurement component 210 can also receive a detector bias signal corresponding to DC bias associated with operation of a power detector that provides the power signal. The power measurement component thus can employ the detector bias signal to compensate for detector bias when computing the indication of power. The respective power measurements for the I and Q signal paths can be stored in memory 212. For example, the memory 212 includes registers or other storage devices 214 and 216 that store the measured power for the I and Q signal paths, respectively. A comparator 218 compares the stored I power and Q power measurements to ascertain a mismatch between the power levels for a given calibration tone. The comparator 218 provides a comparator output signal to the I/Q phase control 208 that can implement further adjustments to the I and Q signal components based on the comparator output signal.

The I/Q phase control 208 can be programmed to implement an algorithm to ascertain gain and phase mismatches between the I and Q signal components. For instance, regardless of what components of the transmitter contribute to phase and/or gain mismatch, the mismatch can be modeled at any particular frequency as a distortion of the baseband input signal components I_{T} and Q_{T}, which are provided by the signal generator 202.

By way of example and with reference back to FIG. 2, the baseband I_{T} signal component can be represented as:

$${I}_{T}^{′} = {I}_{T} cos ( Δ / 2 ) + G {Q}_{T} sin ( Δ / 2 ) \approx {I}_{T} + \frac{Δ}{2} G {Q}_{T} \qquad Eq . 2$$

and the baseband Q_{T} signal component can be represented as:

$${Q}_{T}^{′} = {I}_{T} sin ( Δ / 2 ) + G {Q}_{T} cos ( Δ / 2 ) \approx {I}_{T} \frac{Δ}{2} + G {Q}_{T} \qquad Eq . 3$$

where G and Δ are the gain and phase imbalances, respectively. In the second set of Eqs. 2 and 3, a small angle approximation (i.e., cos(Δ/2)≈1, sin(Δ/2)≈

$$( i . e . , cos ( Δ / 2 ) \approx 1 , sin ( Δ / 2 ) \approx \frac{Δ}{2} )$$

is utilized to provide a shorthand representation for I_{T} and Q_{T}. By mixing these signals (I_{T} and Q_{T}) to passband, the output S(t) of a power amplifier can be represented as:

$$S ( t ) = A ( {I}_{T} + \frac{Δ}{2} G {Q}_{T} ) cos ( {ω}_{c} t ) - A ( {I}_{T} \frac{Δ}{2} + G {Q}_{T} ) sin ( {ω}_{c} t ) \qquad Eq . 4$$

In Eq. 4, A represents any gain added after the quadrature mixer and ω_{c} is the carrier frequency. Eq. 4 can be considered an indication the output power of an ideal transmitter with distorted inputs I′_{T} and Q′_{T}, which can be re-presented as:

S(t)=AI′_{T} cos(ω_{c}t)−AQ′_{T} sin(ω_{c}t) Eq. 5

The magnitude squared of the transmit signal is the sum of the squares of the components. Accordingly, at the output of the power detector (e.g., 98 in FIG. 2) after low pass filtering, the power measurement provided by the power detector reduces to:

$${S}^{2} = \frac{{A}^{2}}{2} ( {I}_{T}^{′2} + {Q}_{T}^{′2} ) = \frac{{A}^{2}}{2} \{ {I}_{T}^{2} ( 1 + \frac{{Δ}^{2}}{4} ) + {G}^{2} {Q}_{T}^{2} ( 1 + \frac{{Δ}^{2}}{4} ) + 2 Δ G {I}_{T} {Q}_{T} \} \qquad Eq . 6$$

Assuming that Δ²/4 is much less than 1, the terms proportional to Δ²/4 can be dropped to provide that:

$${S}^{2} = \frac{{A}^{2}}{2} ( {I}_{T}^{2} + {G}^{2} {Q}_{T}^{2} + 2 Δ G {I}_{T} {Q}_{T} ) \qquad Eq . 7$$

In Eq. 7, if the sign of either I_{T} or Q_{T} is changed, the magnitude of the transmitted signal decreases. Accordingly, by selecting the transmit signals appropriately, the I/Q phase control 208 can estimate phase and gain imbalances by measuring the magnitudes of the respective signals at the output of the power detector.

By way of further example, if the same baseband signal is applied to both the I_{T} and Q_{T} signal components at the input to the radio transmitter (e.g., I_{T}=Q_{T}=Ψ), then, from Eq. 7, the square magnitude of the vector at the output of the power detector (S₁) becomes:

$${S}_{1}^{2} = \frac{{A}^{2} {Ψ}^{2}}{2} ( 1 + {G}^{2} + 2 G Δ ) \qquad Eq . 8$$

Similarly, by changing the sign of the signal on either the I or Q rail (e.g., I_{T}=−Ψ, Q_{T}=Ψ) the output of the power detector (S₂) can be expressed as:

$${S}_{2}^{2} = \frac{{A}^{2} {Ψ}^{2}}{2} ( 1 + {G}^{2} - 2 G Δ ) \qquad Eq . 9$$

Solving Eqs. 8 and 9 for the phase imbalance Δ yields:

$$Δ = ( \frac{1 + {G}^{2}}{2 G} ) ( \frac{{S}_{1}^{2} - {S}_{2}^{2}}{{S}_{1}^{2} + {S}_{2}^{2}} ) \qquad Eq . 10$$

The gain imbalance G can be determined by generating two additional power detector signals S₃ and S₄ associated with transmitter inputs I_{T}=Ψ, Q_{T}=0 and I_{T}=0, Q_{T}=Ψ, respectively. The square magnitude of the signals generated from these inputs can be expressed as:

$$\begin{matrix}{S}_{3}^{2} = \frac{{A}^{2} {Ψ}^{2}}{2} & Eq . 11 \\ {S}_{4}^{2} = \frac{{G}^{2} {A}^{2} {Ψ}^{2}}{2} & Eq . 12\end{matrix}$$

Eqs. 11 and 12 can be solved for G to provide:

$$G = \sqrt{\frac{{S}_{4}^{2}}{{S}_{3}^{2}}} \qquad Eq . 13$$

From the foregoing, it will be appreciated that the phase imbalance and the gain imbalance can be computed during calibration of the I/Q correction system 200 for different frequencies. The I/Q phase control 208 can thus adjust the respective I and Q signal components to compensate for the computed mismatch at each of the respective frequencies.

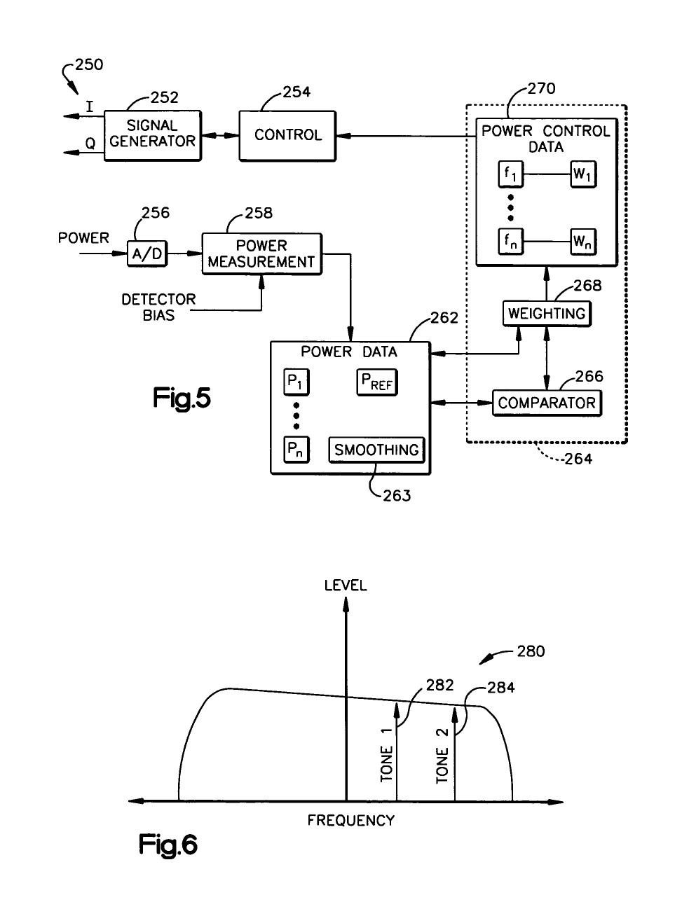

FIG. 5 depicts an example of an equalization system 250 that can be implemented in accordance of an aspect of the present invention. The system 250 can mitigate attenuation across a given frequency band as tends to occur due to filtering at baseband, at the intermediate frequency as well as at RF prior to the signal being sent to the antenna for transmission. In the example of FIG. 5, the system 250 includes a signal generator 252 that provides I and Q signal components at baseband. A control 254 is operative to control each of the I and Q signal components based on calibration performed for each of a plurality of tones in a given frequency band. The following example assumes the signal provided by combining the I and Q signal components corresponds to an orthogonal frequency division multiplexing (OFDM) signal, although it is to be understood and appreciated that the equalization system 250 is equally applicable to other types of modulation.

By way of example, the control 254 controls the signal generator 252 to provide I and Q signal components for each respective tone, there being 52 OFDM tones in an OFDM signal. The system 250 receives an analog indication of POWER (e.g., from a transmit power detector) for each OFDM tone during a calibration phase. The analog indication of POWER is converted to a digital representation thereof by an A/D converter 256.

A power measurement component 258 computes a relative power for a given respective tone based on the digital representation thereof provided by the A/D converter 256. The power measurement component 258 can also receive a detector bias signal indicative of a bias associated with operation of a power detector (not shown), which is coupled to measure the transmit power at the output of the power amplifier. The power measurement component 258 thus can employ the detector bias signal to compensate power measurements for the bias associated with the power detector (e.g., subtracting out the bias from the indication of power) and thereby enable improved equalization correction by the system 250. The power measurement component 258 also provides the indication of power to a power data module 262.

The power data module 262 is operative to store the computed power as power values for each respective tone (e.g., indicated at P₁ through Pₙ). The power data module 262 can also employ a smoothing block 263 to remove possible standing wave ripple components perceived by the power detector (e.g., on the line between the power amplifier 92 and the antenna 94 of FIG. 2). Those skilled in the art will understand and appreciate various approaches (e.g., hardware and/or software algorithms) that can be implemented to achieve suitable smoothing of the transmit signal monitored by the power detector. For example, the smoothing block can be implemented in software as a filter. By mitigating the effects of the detector bias and implementing desired smoothing to reduce ripple effects, the power measurements P₁ through Pₙ can correspond to raw power values associated with respective tones, less any bias added by the power detector.

A reference power value P_{ref} is obtained from the measured power values P₁ through Pₙ corresponding to the power measurement for a reference tone. The reference power P_{ref} is utilized as a basis for a reference tone that provides a desired output power level to which the other reference tones are calibrated. For example, the reference power value P_{ref} can correspond to the tone determined to have the lowest associated transmit energy level from the set of calibration tones.

A calibration system 264 employs the power data from the power data module 262 to calibrate the power levels for each respective tone 1-n relative to the reference power value Pref. For example, the calibration system 264 includes a comparator 266 that compares the indication of power associated with each tone P₁ through Pₙ with Pref. A weighting component 268 computes weighting factors that are to be applied to each tone to pre-weight the power so that the power level for each respective tone matches that of the reference tone indicated by P_{ref}. The pre-weight factors are stored as power control data 270. The power control data associates weighting factors W₁ through Wₙ with the respective frequencies f₁ through fₙ for the n OFDM tones in the signal spectrum.

After the pre-weight factors W₁ through Wₙ have been computed by the weighting function 268, the control 254 can employ the pre-weight factors W₁ through Wₙ to perform an equalization function so that the power levels for each of the respective frequencies f₁ through fₙ in the signal spectrum are substantially equalized relative to the reference tone.

By way of further example, FIG. 6 depicts an example of transmit signal spectrum 280 prior to employing the equalization system 250. In order to demonstrate one approach that can be utilized to implement desired equalization, assume two test tones 282 and 284 are provided by the signal generator 252 with equal amplitudes α₀.

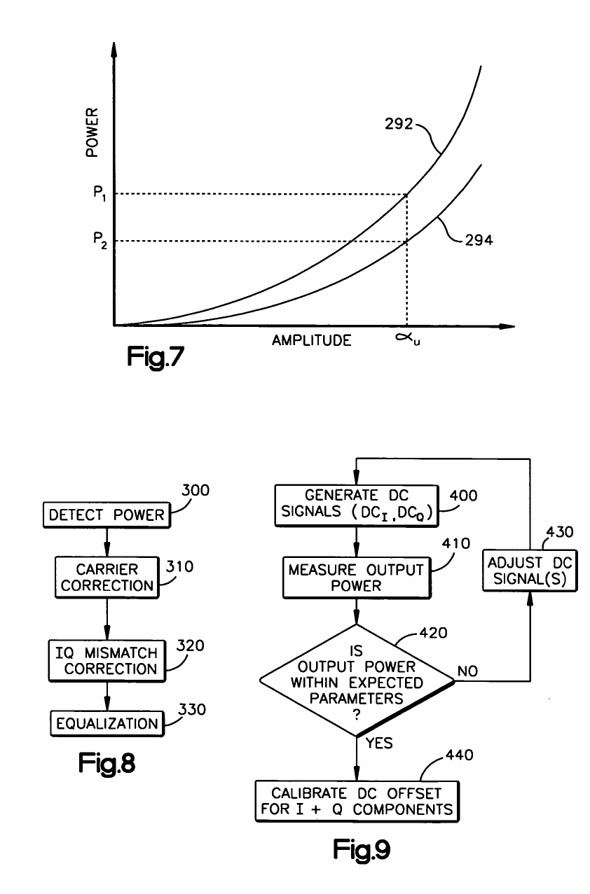

FIG. 7 illustrates a square law response, indicated at 292 and 294, for the power associated with each of the respective tones 282 and 284, such as can be provided by a transmit power detector. The output of the power detector for the two tones (corresponding to the square law responses shown in FIG. 7) 292 and 294 can be represented as:

P₁=λ₁α₀² Eq. 14

P₂=λ₂α₀² Eq. 15

A correction factor f that can be applied to equalize the two tones at the output of the transmitter (wherein tone 284 is utilized as the reference tone) can be expressed as:

$$f = \sqrt{\frac{{P}_{2}}{{P}_{1}}} = \sqrt{\frac{{λ}_{2}}{{λ}_{1}}} \qquad Eq . 16$$

Thus, tone 282 can be equalized to the level of tone 284 at the output of the power amplifier by multiplying the baseband inputs I_{T1} and Q_{T1} by the correction factor f. For example, baseband inputs I_{T1} and Q_{T1} for tone 282 can be represented as:

I_{T1}(t)=fα₀ cos(ωt) Eq. 17

Q_{T1}(t)=fα₀ sin(ωt) Eq. 18

and for tone 284 as:

I_{T2}=α₀ cos(ωt) Eq. 19

Q_{T2}=α₀ sin(ωt) Eq. 20

From the foregoing two-tone example, those skilled in the art will understand and appreciate that a similar approach can be employed to equalize any set of two or more tones, such as the set of OFDM tones that comprise an entire transmit bandwidth. Any one (or more) tones thus can be selected as the reference tone and appropriate correction factors can be computed (e.g., by the weighting function 268). For example, to achieve a substantially equalized spectrum, a correction factor fᵢ can be computed for each tone, as follows:

$${f}_{i} = \sqrt{\frac{{P}_{i}}{{P}_{Re f}}} ; for i \neq Re f \qquad Eq . 21$$

While the above example describes an approach to achieve a substantially equalized spectrum, the approach can be extended to achieve any desired spectral shape. For example, a particular spectral profile may be determined to be more beneficial in certain circumstances than a flat response. Additionally, after equalizing the individual tones to a desired reference power level, it may be necessary to scale the entire transmit signal to maintain a suitable transmit level.

In view of the foregoing structural and functional features described above, certain methodologies that can be implemented will be better appreciated with reference to FIGS. 8-11. While, for purposes of simplicity of explanation, the methodologies of FIGS. 8-11 are shown and described as being implemented serially, it is to be understood and appreciated that the illustrated actions, in other embodiments, may occur in different orders and/or concurrently with other actions. Moreover, not all illustrated features may be required to implement a method according to an aspect of the present invention. It is to be further understood that the following methodology can be implemented in hardware, such as one or more integrated circuits, software, or any combination of hardware and software.

FIG. 8 depicts a methodology that can be utilized to compensate for impairments in a communications system. In one particular aspect, the methodology can be utilized at a transmitter to reduce transmitter impairments associated with, for example, I/Q phase and amplitude imbalance, attenuation distortion in the transmit band and distortion (e.g., spikes) in the carrier level. The methodology can be implemented during a calibration mode (e.g., off line) as well as during normal operation. The methodology begins at 300 in which a transmit power is detected. The transmit power provides an indication of the measured energy associated with a signal spectrum and/or individual tones in the signal spectrum.

At 310, carrier correction is implemented. The carrier correction can be implemented based on the detected power at 300 for a transmit signal containing no data (e.g., carrier only). The carrier correction can be implemented by adjusting the DC levels of I and Q signal components so as to minimize the carrier level in the transmit signal, such as to a level generally commensurate with the level of the tones in the signal spectrum.

At 320, I/Q mismatch correction is performed. The I/Q signal component mismatch can be implemented by measuring the power at 300 associated with calibration tones provided separately for respective I and Q signal components. Based on the measured energy levels for the respective I and Q signal components for various calibration tones, gain and phase mismatch associated with the respective I and Q channels (e.g., represented as a ratio between the respective I and Q channel) can be ascertained. The detected mismatch can then be utilized to provide compensation signals for each of the respective I and Q components during the normal operating mode.

At 330, equalization correction is performed. The equalization correction can be implemented based on the detected power at 300 for each of the plurality of tones (or at least a selected subset thereof), for a given signal spectrum. Power associated with each of the tones can be compared to a measured power value for a selected reference tone and the other tones can then be weighted accordingly to provide a desired spectral (e.g., an equalized or curved) shape across the signal spectrum.

It is to be appreciated that additional benefits can be utilized by performing the compensation with carrier correction (310) first, I/Q mismatch correction (320) next and equalization (330) thereafter. This is because energy in the carrier can further affect the measurements associated with the I/Q phase mismatch. Additionally, the I/Q phase mismatch can extend into the equalization. Thus, by performing the different phase of correction in order can further improve transmitter performance. Those skilled in the art will appreciate that the compensation can also be performed in different orders from that described herein.

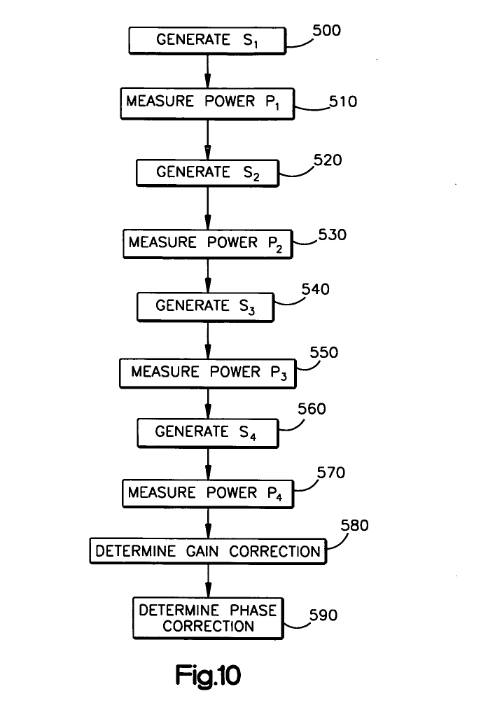

FIG. 9 depicts an example of a methodology that can be utilized to implement carrier correction in accordance with an aspect of the present invention. The methodology begins at 400 in which DC signals are generated for I and Q components, indicated at DC_{I} and DC_{Q}. At 410, output power is measured for the transmit signal based on the DC_{I} and DC_{Q} signal components generated at 400.

At 420, a determination is made as to whether the output power is within expected parameters. If the output power is not within expected parameters (NO), the methodology proceeds to 430. At 430, the DC_{I} and DC_{Q} signal components are adjusted and the methodology returns to 400 in which the adjusted DC levels are utilized to generate additional DC signals for the I and Q signal components. If the output power at 420 is within expected operating parameters (YES), the methodology proceeds to 440 in which the DC offset components are calibrated for the I and Q signal components. The calibrated DC_{I} and DC_{Q} signal components can be utilized during normal operation to mitigate carrier spikes that can be associated with the transmit signal.

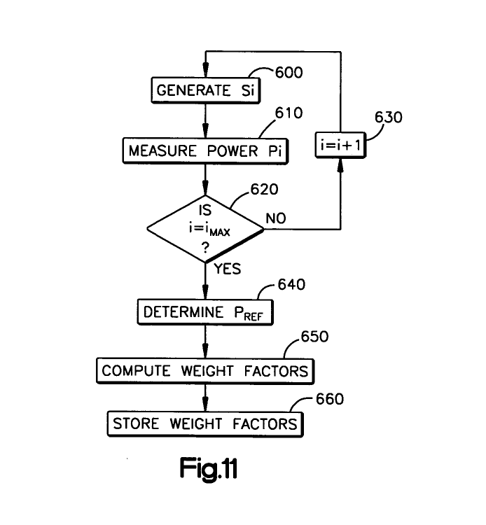

FIG. 10 depicts a methodology that can be utilized for I and Q compensation in accordance with an aspect of the present invention. The methodology begins at 500 in which transmit signal S₁ is generated, such as at baseband in which I and Q signal components are substantially equal (e.g., I_{T}=Q_{T}=Ψ). At 510, a corresponding power P₁ is measured at 510 based on the generated transmit component associated with the S₁ signal. The measured power P₁ can be stored for subsequent calculations. At 520, a transmit signal is generated, such as at baseband in which I and Q-signal components are substantially equal in magnitude, but have opposite signs (I_{T}=Q_{T}=−Ψ), and a corresponding power P₂ is measured at 530. The measured power P₂ corresponds to the transmit signal S₂.

At 540, an additional transmit signal S₃ is generated, such as based on a baseband inputs for an I-signal component having a desired magnitude (e.g., I_{T}=Ψ and Q_{T}=0). Associated power P₃ is measured at 550 for the signal generated at 540. At 560, another signal S₄ is generated, such as in which Q_{T}=Ψ and the in-phase signal component 0I_{T}==0. The power of P₄ is measured at 570 for the signal S4 generated at 560. At 580, a gain imbalance (G) can be determined as a function of the powers measured at 550 and 570, such as indicated above in Eq. 13. At 590, a phase imbalance (Δ) is determined based on the measured powers P₁ and P₂ and the gain G determined at 580. The phase imbalance or mismatch (Δ) thus can be computed based on the Eq. 10 indicated above. Accordingly, by using the gain and phase estimates determined at 580 and 590, the I and Q signal components can be adjusted for each transmit signal to pre-correct or compensate for the relative gain and/or phase imbalances associated with the I and Q signal channels.

FIG. 11 depicts a methodology that can be utilized to perform equalization correction in accordance with an aspect of the present invention. The methodology begins at 600 in which a signal (Sᵢ) is generated for a selected one of a plurality of frequency tones in a given signal spectrum, where i denotes the selected tone. At 610, the power Pᵢ is measured for the signal generated at 600. At 620, a determination is made as to whether power has been measured for each of the plurality of signal tones in the spectrum. If additional tones exist (NO), the methodology proceeds to 630 in which the signal Sᵢ is incremented (i=i+1) to provide a next signal tone. The methodology then returns to 600. After signals Sᵢ have been generated at 600 and power has been measured at 610 for each of the plurality of tones (YES), the methodology proceeds from 620 to 640. At 640, a reference measured power (P_{REF}) is determined for a selected one of the signals Sᵢ generated at 600. The reference power P_{REF}, for example, can correspond to a minimum power level detected at 610 for a corresponding one of the signals Sᵢ (e.g., a reference frequency tone).

At 650, weight factors are computed for each of the other tones as a function of the reference power P_{REF}. The weight factors for each of the frequency tones can provide an indication of the reference power P_{REF} relative to the measured power Pᵢ for each of the other respective tones. For example, the weight factor can correspond to a ratio of P_{REF} and Pᵢ for each of the respective i tones (e.g., see Eq. 21). Thus, by multiplying the weight factor by the power levels for a given tone, such as during normal operation, the signal spectrum can be substantially equalized to substantially the same the level as the reference tone. Those skilled in the art will appreciate that different weight factors can be computed to provide other spectral shapes. At 660, the weight factors can be stored for use during normal operation.

What has been described above includes examples and implementations of the present invention. Because it is not possible to describe every conceivable combination of components, circuitry or methodologies for purposes of describing the present invention, one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A correction system comprising:
a power detector that provides an indication of power associated with a transmitter output signal; and
a compensation system that employs the indication of power to compensate for at least one transmitter impairment affecting the transmitter output signal.

2. The system of claim 1, the compensation system being configured to selectively adjust at least one of an in-phase (I) signal component and a quadrature (Q) signal component based on the indication of power to mitigate distortion characteristics in the transmitter output signal.

3. The system of claim 2, the indication of power further comprising a relative power measured by the power detector associated with the respective I and Q signal components.

4. The system of claim 1, the compensation system further comprising a carrier correction system that adjusts DC offset of at least one of an in-phase (I) signal component and a quadrature (Q) signal component utilized to provide the transmitter output signal based on the indication of power to mitigate spikes in the carrier level of the transmitter output signal.

5. The system of claim 1, the compensation system further comprising an equalization system that adjusts tones in a signal spectrum employed to provide the transmitter output signal so that the signal spectrum has a desired spectral shape, the equalization system adjusting the tones in the signal spectrum during calibration based on the indication of power.

6. The system of claim 5, the equalization system selectively weighting tones in the signal spectrum based on an indication of power associated with the tones in the signal spectrum relative to an indication of power associated with a reference tone in the signal spectrum.

7. The system of claim 6, further comprising:
a comparator that compares a power characteristic associated with each of the tones in the signal spectrum relative to a power characteristic of the reference tone to provide an indication of relative power for each respective tone; and
a weighting function that employs the indication of relative power for each respective tone to adjust each respective tone to a desired level relative to the reference tone.

8. The system of claim 7, the weighting function being applied to adjust at least one of the I-signal component and the Q-signal component of the transmitter output signal to provide the desired spectral shape.

9. The system of claim 1, further comprising a detector bias component configured to determine a DC bias associated with operation of the power detector, the compensation system employing the DC bias to mitigate effects of the DC bias in the indication of power.

10. The system of claim 1, the compensation system is operative to adjust at least one of an in-phase (I) signal component and a quadrature (Q) signal component based on the indication of power to compensate for at least one of a gain and phase mismatch between a signal path for the I-signal component and a signal path for the Q-signal component.

11. The system of claim 1, further comprising a mismatch correction system operative to ascertain an indication of at least one of a gain and phase mismatch between an in-phase (I) signal component and a quadrature (Q) signal component based on the indication of power, the mismatch correction system adjusting at least one of the I-signal component and the Q-signal component based on the indication of the mismatch between I and Q signal components.

12. The system of claim 11, the mismatch correction system further comprising:
a comparator that compares the indication of power associated with the I-signal component and the indication of power associated with Q-signal component to provide an indication of relative power characteristics corresponding to the mismatch associated with a signal path for the I-signal component and a signal path for the Q-signal component; and
a control operative to adjust at least one of the I and Q signal components based on the indication of the relative power characteristics.

13. An integrated circuit comprising the system of claim 1.

14. A communications apparatus comprising:
a baseband system that provides in-phase (I) and quadrature (Q) signal components;
a correction system associated with the baseband system for adjusting at least one of the I and Q signal components based on an indication of power of a transmit signal to compensate for impairments associated with the communications apparatus;
a transmitter that provides the transmit signal based on the adjusted I and Q signal components; and
a power detector that detects power associated with the transmit signal and provides the indication of power.

15. The apparatus of claim 14, the correction system further comprising a carrier correction system that adjusts a level of at least one of the I and Q signal components based on the indication of power to compensate for an impairment associated with the communications apparatus that affects a level of the carrier signal in the transmit signal.

16. The apparatus of claim 15, the correction system further comprising an equalization system that adjusts tones in a signal spectrum corresponding to the transmit signal based on the indication of power so that the signal spectrum has a desired spectral shape.

17. The apparatus of claim 16, the equalization system selectively weighting tones in the signal spectrum based on an indication of power associated with the tones in the signal spectrum relative to the indication of power associated with a reference tone in the signal spectrum.

18. The apparatus of claim 16, the correction system further comprising a mismatch correction system operative to ascertain, based on the indication of power, an indication of mismatch associated with a signal path for the I-signal component and a signal path for the Q-signal component, the mismatch correction system adjusting at least one of the I-signal component and the Q-signal component based on the indication of the mismatch between I and Q signal components.

19. The apparatus of claim 18, wherein the mismatch further comprises at least one of a phase imbalance and a gain mismatch caused by circuitry in the signal path for the I-signal component and the signal path for the Q-signal component.

20. An integrated circuit comprising the system of claim 14.

21. A transmitter system comprising:
means for determining an indication of power associated with a transmit output signal; and
means for compensating for distortion in the transmit output signal based on the indication of power.

22. The system of claim 21, further comprising means for shaping a signal spectrum in the transmit output signal by adjusting at least one of an in-phase (I) signal component and a quadrature (Q) signal component based on the indication of power.

23. The system of claim 21, further comprising means for, based on the indication of power, compensating for at least one of gain and phase mismatch associated with an in-phase signal path and a quadrature signal path of the transmitter system.

24. The system of claim 21, further comprising means for mitigating spikes in a carrier signal of the transmit signal by applying a DC signal to, based on the indication of power, adjust at least one of an in-phase (I) signal component and a quadrature (Q) signal component.

25. The system of claim 21, wherein the impairments comprise at least one of spikes in a carrier signal of the transmit signal, attenuation distortion in a signal spectrum corresponding to at least a portion of the transmit signal, a gain mismatch associated with an in-phase (I) signal path and a quadrature (Q) signal path, and a phase mismatch associated with the I-signal path and the Q-signal-path.

26. The system of claim 25, further comprising means for calibrating the means for compensating to mitigate the impairments.

27. The system of claim 26, the means for calibrating further comprising:
means for providing at least one calibration tone having an I-signal component and a Q-signal component; and
means for adjusting at least one of the I-signal component and the Q-signal component based on the indication power, the means for compensating employing the adjusted at least one of the I-signal component and the Q-signal component to mitigate the impairments.

28. A method to correct impairments associated with a communications apparatus, the method comprising:
detecting an indication of power associated with a transmit signal; and
selectively adjusting at least one of an in-phase (I) signal component and a quadrature (Q) signal component based on the indication of power to compensate for impairments associated with the communications apparatus that affect the transmit signal.

29. The method of claim 28, further comprising applying a DC offset for at least one of the I-signal component and the Q-signal component to mitigate spikes in a carrier for the transmit signal.

30. The method of claim 28, further comprising adjusting at least one of the I-signal component and the Q-signal component based on the indication of power to mitigate at least one of gain and phase mismatches associated with an I-signal path and a Q-signal path to which the respective I-signal component and the Q signal component are provided.

31. The method of claim 30, further comprising:
determining an indication of a phase imbalance associated with the I-signal path and the Q-signal path;
determining an indication of a gain mismatch associated with the I-signal path and the Q-signal path; and
calibrating the adjustments to the at least one of the I-signal component and the Q-signal component based on the indication of the phase imbalance and the indication of the gain mismatch.

32. The method of claim 28, further comprising applying weight factors to at least one of the I-signal component and the Q-signal component for tones that form a signal spectrum of the transmit signal for adjusting a spectral shape of the transmit signal.

33. The method of claim 32, further comprising determining a weight factor for each of the tones based on an indication of power associated with each respective one of the tones relative to an indication of power associated with a reference one of the tones.
